(19) United States
(12) Patent Application Publication
(10) Pub. No.: US 2008/0065729 A1
(43) Pub. Date: Mar. 13, 2008

(54) Method and system for service provider to be compensated for delivering e-mail messages while reducing amount of unsolicited e-mail messages

(75) Inventor: Bertrand Haas, New Haven, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/518,101

(22) Filed: Sep. 8, 2006

(51) Int. Cl. H04L 9/00; G06F 15/16

(52) U.S. Cl. 709/206; 713/150

(57) ABSTRACT

Methods and systems for sending e-mail messages are provided. A sender of an e-mail pays a sending fee to the service provider for each e-mail sent. Each e-mail message includes a portion that is encrypted by the sender. If the recipient desires to read the encrypted portion, the recipient will request the corresponding decryption key from the service provider. The service provider sends the decryption key to the recipient, who can then decrypt the encrypted portion of the e-mail message for reading. The service provider refunds the sending fee, or some portion thereof, to the sender for each e-mail message for which the recipient requests the decryption key, while retaining the sending fee for those e-mails for which a decryption key was not requested.

### FIELD OF THE INVENTION

The invention disclosed herein relates generally to information delivery via computer networks, and more particularly to a method and system for a service provider to be compensated for delivering e-mail messages that will reduce the amount of unsolicited e-mail messages sent via computer networks.

### BACKGROUND OF THE INVENTION

The growth of the Internet has made e-mail a popular communication method for many people along with many commercial businesses. Such businesses can utilize e-mail messages for advertising purposes by mass e-mailing advertising messages to large numbers of e-mail addresses. Unfortunately, many people find the practice of mass e-mailing, also referred to as spamming, to be both aggravating and time consuming, as it can result in receipt of numerous unwanted e-mail messages every day. In many instances, the recipient may need to actually open the e-mail message and review it before determining that it is an unwanted solicitation and deleting it, thereby wasting valuable time. In addition, if the recipient's Internet Service Provider (ISP) limits the amount of e-mail that can be accepted or stored, unwanted e-mail messages can prevent a recipient from actually receiving e-mail messages that are important or desired.

Numerous attempts have been made to reduce the amount of spam, including the filtering of unsolicited e-mails by only accepting e-mails from authorized addresses or rejecting e-mails from known spammers. This approach, however, relies on the accuracy of the respective lists and must be continually updated to be effective. Additionally, sophisticated spammers have developed numerous methods to defeat such filters, thereby rendering them ineffective.

Another problem created by spamming is an increase in the amount of network message traffic, thereby potentially adversely impacting system performance of the network. In many situations, the ISP is not compensated based on the amount of e-mail messages delivered, thus allowing spammers to send unrestricted amounts of e-mail. Attempts to charge e-mail senders based on the amount of e-mail messages delivered have been met with considerable resistance and generally found to be unworkable, as such charges do not discriminate between spammers and legitimate e-mailers. In particular, many legitimate businesses and organizations, including non-profit organizations, public interest organizations and the like, would still be charged for sending e-mails that recipients actually desired to receive.

Thus, there exists a need for a method and system for selectively compensating service providers for delivering unsolicited and/or unwanted e-mail messages that will help to reduce the amount of unsolicited and/or unwanted e-mail messages being sent.

### SUMMARY OF THE INVENTION

The present invention alleviates the problems associated with the prior art and provides methods and systems that selectively compensates service providers for delivering unsolicited and/or unwanted e-mail messages that can reduce the amount of unsolicited and/or unwanted e-mail messages being sent.

In accordance with embodiments of the present invention, a sender of an e-mail pays a sending fee to the service provider for each e-mail sent. Each e-mail message includes a portion that is encrypted, preferably utilizing an Identity Based Encryption (IBE) scheme. The encrypted portion of the e-mail message includes some portion that the recipient would want to read if the recipient deemed the e-mail message to be of some value, such as, for example, important information (dates, addresses), a coupon, a music single, a short video, product images, etc. In an IBE scheme, the encryption key used to encrypt the portion of the e-mail message is computed using information associated with the message that preferably includes, for example, the recipient's e-mail address, that is optionally combined with other information, such as, for example, the date of the e-mail message and/or an identification number for the e-mail message. The encryption key can be provided to the recipient in the unencrypted part of the message. If the recipient desires to read the encrypted portion, the recipient will return the encryption key to the sender's service provider, which can then generate the corresponding decryption key for that e-mail message.

The service provider sends the generated decryption key to the recipient, who can then decrypt the encrypted portion of the e-mail message for reading. The service provider refunds the sending fee, or some portion thereof, to the sender for each e-mail message for which the recipient requests the decryption key, while retaining the sending fee for those e-mails for which a decryption key was not requested. Optionally, the service provider can also provide to the sender the e-mail address for those recipients that requested the decryption key, thereby providing valuable marketing information to the sender for possible future e-mails. Thus, a sender will be motivated to only send e-mails that are deemed valuable and wanted by a recipient, as the sender will be refunded the sending fee for such e-mails. As a result, recipients will receive reduced amounts of unwanted and/or unsolicited e-mails. Additionally, the service provider will be compensated for those e-mails for which a decryption key is not requested. The overall result will be a reduction in the amount of unsolicited and/or unwanted e-mail messages being sent and service providers being compensated only for delivering unsolicited and/or unwanted e-mail messages.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a system according to an embodiment of the present invention;

FIG. 2 illustrates in block diagram from a private key generator that is used according to an embodiment of the present invention; and

FIG. 3 illustrates in flow diagram form the operation of the system of FIG. 1 according to an embodiment of the present invention.

### DETAILED DESCRIPTION OF THE PRESENT INVENTION

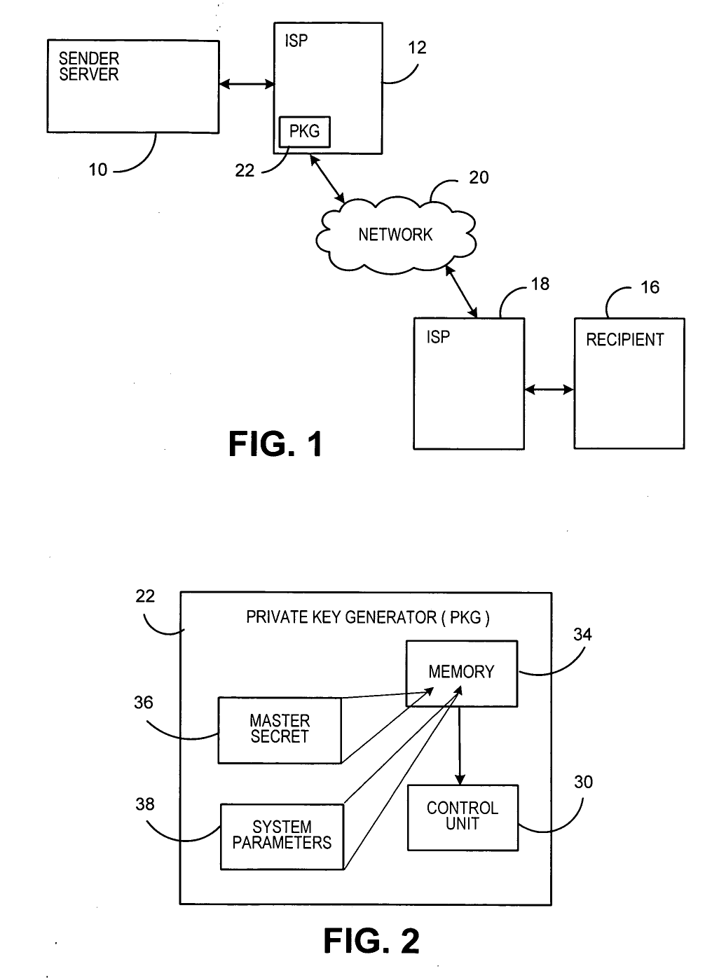

In describing the present invention, reference is made to the drawings, where there is seen in FIG. 1 in block diagram form an e-mail system according to an embodiment of the present invention. The system includes a sender server 10 that is communicatively coupled to an Internet Service provider (ISP) 12 via any conventional means, including, for example, via telephone line, broadband connection, etc. Sender server 10 may be any type of processor based system. ISP 12 provides connection services for the sender server 10 to a network 20, such as, for example, the Internet, and also provides services for the sender server 10 to send e-mail messages via the network 20. A recipient 16 is coupled to an ISP 18, which may or may not be the same as ISP 12. Recipient 16 may be any type of processing system, such as, for example, a personal computer. ISP 18 provides the recipient 16 with access to network 20, and also manages receipt and delivery of e-mail messages to/from recipient 16 based on an e-mail address that uniquely identifies the recipient 16. The concept of service providers and e-mail systems are well known in the art and need not be described in further detail.

The ISP 12 includes a private key generator (PKG) 22. Alternatively, a PKG 22 can be operated by a third party for utilization by ISP 12. In this scenario, PKG 22 is preferably a trusted party, such as, for example, a reliable and reputable commercial entity or governmental entity. Referring to FIG. 2, there is illustrated in block diagram form a PKG 22, which as noted above with respect to FIG. 1, may either be part of the ISP 12 or independent thereof. The PKG 22 is used to generate and manage the cryptographic keys utilized in the present invention. PKG 22 has knowledge of a secret master key and utilizes a control unit 30, such as an information processor or the like, to generate a corresponding private key for each given public key as described below. The PKG 22 performs a setup procedure to generate a master secret parameter 36 and system parameters 38 associated with the specific encryption/decryption algorithm utilized to encrypt/decrypt information. The master secret parameter 36 includes, for example, some integer known only to the PKG 22. The system parameters 38 include, for example, elliptic curve parameters associated with specific points on the curve used in the encryption algorithm, and are made publicly available for use as described below. The master secret parameter 36 and system parameters 38 can be stored in the securely protected memory 34. The master secret parameter 36 and system parameters 38 are used by the control unit 30 of PKG 22 to generate corresponding decryption keys as described below. The system parameters 38 are also used in encrypting at least a portion of an e-mail message as described below.

The present invention utilizes a public key cryptosystem to allow the ISP 12 to charge for e-mails sent by the sender server 10 that are deemed to be unwanted by a recipient. In such an encryption scheme, a public-key cryptosystem is utilized to encrypt/decrypt some portion of each e-mail message sent by the sender server 10. Public-key cryptosystems allow two parties to exchange private and authenticated messages without requiring that they first have a secure communication channel for sharing private keys. In a public-key cryptosystem, each party has a unique pair of keys: a private key that is a secret and a public key that is widely known and can be obtained and used by any party without restrictions. This pair of keys has two important properties: (1) the private key cannot be deduced from knowledge of the public key and the message, and (2) the two keys are complementary, i.e., a message encrypted with one key of the pair can be decrypted only with the complementary key of the pair. In one particular type of public-key cryptosystem, a party's public key can be computed from a standardized public identifier associated with the party, such as, for example, the party's name, unique identification, e-mail address, etc. Because the public key is a publicly known function of only the party's pre-existing public identifier rather than a key produced from a random seed, this kind of public-key cryptosystem is called an identity-based encryption (IBE) scheme. One implementation of an IBE scheme is described in detail in U.S. Published Patent Application No. 2003/0081785 A1, the disclosure of which is incorporated herein by reference.

The preferred IBE scheme utilized to implement the present invention is described in detail in the aforementioned U.S. Published Patent Application No. 2003/0081785 A1, although other similar IBE schemes may also be used. The preferred IBE scheme utilizes public keys that each consists of an arbitrary string derived from one or more identity related parameters for each e-mail message, such as, for example, the e-mail address of the recipient, the date of the e-mail message, an identification number for the e-mail message, or the like. It should be understood, of course, that a standard public key encryption scheme or a symmetric key scheme can also be utilized in the present invention.

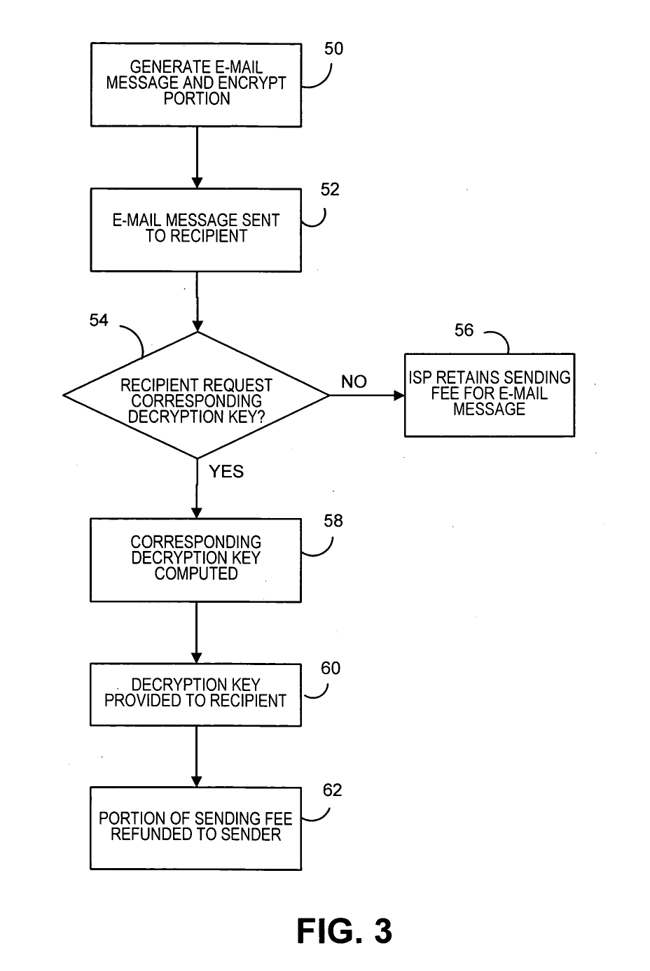

Referring now to FIG. 3, there is illustrated in flow diagram form the operation of the system of FIG. 1 for sending e-mail according to an embodiment of the present invention. Suppose, for example, that a sender, using the sender server 10, desires to send an e-mail to a recipient 16. While the present description will be given with respect to a single e-mail to a single recipient, it should be understood that similar processing applies for any number of e-mail messages to any number of recipients. In step 50, the e-mail message to the recipient 16 is generated by, for example, the sender server 10, and some portion of the e-mail message is encrypted. Preferably, the portion encrypted includes some information that the recipient 16 will deem valuable and want to read, such as, for example, important information (dates, addresses), a coupon, a music single, a short video, product images, or the like. The sender server 10 can encrypt the portion of the e-mail message using a known encryption algorithm, including the system parameters 38, provided by the PKG 22, and an encryption key computed by the sender server 10. The encryption key, also referred to herein as the public key, can be computed using identity-based information associated with the e-mail message, such as, for example, the e-mail address of the recipient 16 and the date of the e-mail message. Decryption of the encrypted information requires the use of a corresponding decryption key, also referred to herein as the private key.

Since the e-mail address of the recipient 16 is preferably used as an input to generate the encryption key, the encryption key (public key), and hence the corresponding decryption key (private key), will be different for each different recipient 16. Additionally, since the date of the e-mail message is also preferably used as an input to generate the encryption key, the corresponding private key will be different depending upon the sending date for every e-mail message. Thus, an e-mail message sent to recipient 16 on January 1 will utilize a different set of keys than an e-mail message sent to the same recipient 16 on January 2. Optionally, the encryption key can also be computed using a unique identification number for each e-mail message, such as, for example, the exact time of sending the e-mail message, thus ensuring that even if several e-mail messages are sent to the same recipient 16 on the same date, each of the e-mail messages will utilize a different set of encryption/decryption keys. Optionally, the sender server 10 could send the e-mail message, along with the desired information to be used as inputs for computing the encryption key, to the PKG 22 and the PKG 22 can perform the necessary processing to generate the encryption key and encrypt the portion of the e-mail message.

In step 52, the e-mail message, including the encrypted portion, is sent to the recipient 16. The encryption key used to encrypt the portion of the e-mail message can optionally also be sent to the recipient 16. The encryption key need not be protected and can be sent in the clear, since as noted above the private key cannot be deduced from knowledge of the public key and the message. Thus, the sender server 10, the recipient 16, or any other party, except for the PKG 22, can not deduce the corresponding decryption key (the private key) simply by knowing the encryption key (the public key) and the content of the message encrypted. Optionally, the ISP 12 can maintain a list of some data for all e-mail messages sent for a sender that can include one or more of the following: the recipient's e-mail address, date of sending, time of sending, and encryption key used.

According to the present invention, the sender has agreed to pay the ISP 12 a sending fee for each e-mail message sent by the sender server 10 and delivered to a recipient via the ISP 12. The ISP 12 will reduce, or refund, some portion, or all, of the sending fee for those e-mail messages sent by the sender server 10 that the recipient 16 has deemed to be of value, while maintaining the full amount of the sending fee that the recipient 16 has not deemed to be of value. Thus, there is a financial incentive for senders to only send e-mails that recipients will deem valuable. An e-mail is deemed to be valuable to a recipient 16 if the recipient 16 desires to read the entire e-mail message, including the portion that was encrypted. Thus, it is in best interest of the sender to ensure that the portion encrypted includes some information that the recipient will want to read.

If the recipient 16 desires to read the full e-mail message, the recipient 16 can request the corresponding decryption key for that e-mail message from the PKG 22. This can be performed using an embedded reply link in the e-mail message that, if accessed by the recipient 16, will provide the encryption key used to encrypt the portion of the e-mail message to the PKG 22. Alternatively, an embedded reply link could provide the information used to generate the encryption key used to encrypt the portion of the e-mail message, e.g., e-mail address of recipient 16, date, identification number, such that the PKG 22 can generate the encryption key. The PKG 22, upon receiving (or generating) the encryption key and having knowledge of the system parameters 38 and master secret 36, can then generate the corresponding decryption key (the private key). Optionally, the embedded reply link can also be used to automatically send a notice to the sender server 10 when the recipient 16 requests the decryption key from the ISP 12. Through use of these automatic replies, the sender will know exactly for which e-mail messages the full sending fee should not be paid, thereby allowing the sender to reconcile accounting with the ISP 12.

In step 54, it is determined if the recipient 16 of the e-mail message has requested the corresponding decryption key for the e-mail message from the PKG 22. Optionally, some type of time frame can be agreed upon by the sender and ISP 12 as to the time allowed for a recipient 16 to request the decryption key. If the recipient 16 has not requested the decryption key within the agreed upon time frame, then in step 56 the ISP will retain all of the sending fee the sender paid to the ISP 12 for that e-mail message. Alternatively, if the ISP 12 bills the sender in a post-payment billing type of payment system, the IPS 12 will bill the sender for the full amount of the sending fee for that e-mail message. If in step 54 it is determined that the recipient 16 has requested the corresponding decryption key for an e-mail message sent by the sender server 10, then in step 58 the PKG 22 will compute the corresponding decryption key for that e-mail message (based on the used encryption key, system parameters 38 and master secret 36).

In step 60, the computed decryption key is sent to the recipient 16 (by the ISP 12 or directly by the PKG 22 if a third party). In step 62, the ISP 12 refunds some portion, or all, of the sending fee to the sender for that e-mail message. If a post-payment billing system is utilized, then the ISP 12 will reduce the amount of the sending fee for delivering that e-mail message by some amount, e.g., the entire amount or some portion thereof, by removing the sending fee or reducing the sending fee for that e-mail message before the bill is sent to the sender. If the ISP maintains a list of some e-mail data for all e-mail messages delivered for a sender, the ISP 12 can correlate the requests for decryption keys from recipients with the list of e-mail messages sent to facilitate accounting for each sender. For example, those e-mail messages for which the corresponding decryption key has been requested can be marked on the list as non-billable or reimbursable (depending on the payment system utilized). The ISP 12 may automatically reimburse the sender, or wait until a request is received from the sender for reimbursement for specific e-mail messages. Optionally, the ISP 12 can also provide the e-mail addresses for those recipients that did request a decryption key to the sender server 10, thereby providing the sender with valuable marketing information for future e-mail messages. Such marketing information could include, for example, which recipients found e-mail messages relating to a specific topic valuable, which were found not valuable, etc., for future targeted advertising.

While the above description was described with respect to an IBE scheme, other encryption schemes can also be utilized in the present invention. For example, the ISP 12 can generate an encryption/decryption key pair and provide the encryption key to the sender. The sender can utilize the encryption key to encrypt a portion of the e-mail message and provide the encryption key (or an identification number of the encryption key) to the recipient 16. If the recipient 16 wishes to read the entire e-mail message, the recipient 16 will request the decryption key from the ISP 12 by providing either the actual encryption key or the identification number used to encrypt the e-mail message to the ISP 12. Using a look-up table or the like, the ISP 12 can provide the recipient with the corresponding decryption key and then reimburse the sender as described above. This embodiment, however, requires significant key management capabilities on the part of the ISP 12, as the ISP 12 must be able to generate, log and store very large numbers of keys.

Thus, the present invention will selectively compensate the service provider for delivering unsolicited and/or unwanted e-mail messages, while acting to reduce the amount of unsolicited and/or unwanted e-mail messages being sent. Senders of e-mail messages will be motivated to only send e-mails that are deemed valuable and wanted by a recipient, as the sender will be refunded the sending fee (or some portion thereof) for such e-mails. For those e-mail messages not deemed valuable, the sender will have to pay the full sending fee. Thus, a sender will have to pay a fee for sending an e-mail message that is not deemed valuable by a recipient, while paying a lesser fee (which may be zero) for sending an e-mail message that is deemed valuable by a recipient. As a result, senders are much less likely to engage in mass e-mailing campaigns (spamming), and therefore recipients will receive reduced amounts of unwanted and/or unsolicited e-mails. Additionally, the service provider will be compensated for those e-mails for which a decryption key is not requested. The overall result will be a reduction in the amount of unsolicited and/or unwanted e-mail messages being sent and service providers being compensated only for delivering unsolicited and/or unwanted e-mail messages.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A method for a service provider to be compensated for delivering an e-mail message for a sender, the method comprising:
delivering the e-mail message for the sender to an e-mail address for a recipient, the e-mail message including at least a portion that is encrypted with a encryption key;
charging the sender a sending fee for delivery of the e-mail message to the e-mail address for the recipient;
determining if the recipient has requested a corresponding decryption key for the encryption key; and
if the recipient has requested the corresponding decryption key, reducing the sending fee to the sender for delivery of the e-mail message.

2. The method according to claim 1, wherein the encryption key is based on the recipient's e-mail address.

3. The method according to claim 2, wherein the encryption key is further based on a date of the e-mail message.

4. The method according to claim 3, wherein the encryption key is further based on a unique identification number associated with the e-mail message.

5. The method according to claim 3, wherein the encryption key is further based on a time of sending of the e-mail message.

6. The method according to claim 1, wherein reducing the sending fee further comprises:
refunding at least a portion of the sending fee to the sender.

7. The method according to claim 1, determining if the recipient has requested a corresponding decryption key for the encryption key further comprises:
determining if the recipient has requested a corresponding decryption key for the encryption key within a predetermined time period.

8. The method according to claim 1, wherein charging the sender a sending fee for delivery of the e-mail message further comprises:
preparing a bill for sending to the sender for delivery of the e-mail message.

9. The method according to claim 8, wherein reducing the sending fee further comprises:
reducing the sending fee on the bill prepared for the sender.

10. A method for a service provider to be compensated for delivering an e-mail message for a sender, the method comprising:
delivering the e-mail message for the sender to an e-mail address for a recipient, the e-mail message including at least a portion that is encrypted with a encryption key based on the recipient's e-mail address;
charging the sender a first fee for delivery of the e-mail message to the e-mail address for the recipient if the recipient has not requested a corresponding decryption key for the encryption key within a predetermined time period; and
charging the sender a second fee for delivery of the e-mail message to the e-mail address for the recipient if the recipient has requested the corresponding decryption key within the predetermined time period, the second fee being less than the first fee.

11. The method according to claim 10, wherein the encryption key is based on the recipient's e-mail address.

12. The method according to claim 11, wherein the encryption key is further based on a date of the e-mail message.

13. The method according to claim 12, wherein the encryption key is further based on a unique identification number associated with the e-mail message.

14. The method according to claim 10, wherein the second fee is zero.
